(19) United States
(12) Patent Application Publication
(10) Pub. No.: US 2019/0168567 A1
(43) Pub. Date: Jun. 6, 2019

(54) AIR CONDITIONING DEVICE FOR A MOTOR VEHICLE

(71) Applicant: Volkswagen Aktiengesellschaft, Wolfsburg (DE)

(72) Inventors: Stefan SCHMITT, Velkpe (DE); Gregor HOMANN, Wolfsburg (DE)

(73) Assignee: Volkswagen Aktiengesellschaft, Wolfsburg (DE)

(21) Appl. No.: 16/322,309

(22) PCT Filed: Jul. 26, 2017
(86) PCT No.: PCT/EP2017/068944

§ 371 Date: Jan. 31, 2019

(30) Foreign Application Priority Data
Aug. 1, 2016 (DE) 10 2016 214 116.3

(51) Int. Cl. B60H 1/00

(52) U.S. Cl. CPC B60H 1/00057; B60H 1/00335; B60H 2001/0015; B60H 2001/00128; B60H 1/00678

(57) ABSTRACT

The invention relates to an air conditioning device for a motor vehicle, comprising, arranged in a housing (10), a first heat exchanger (21), through which an air flow (14) can flow and which can be operated as an evaporator of a refrigerant circuit, a second heat exchanger (20, 22) connected downstream of the first heat exchanger in the flow direction of the air flow (14), through which the air flow (14) can flow, and which is provided with a resistance heating element, and further comprising an air guiding flap (30) designed as a bypass flap, by way of which, depending on their position, parts of the air flow (14) can be guided past the second heat exchanger (20, 22).

The invention relates to an air conditioning device for a motor vehicle, including, situated in a housing,
a first heat exchanger through which an air stream may flow and which is operable as an evaporator of a refrigerant circuit,
a second heat exchanger, connected downstream from the first heat exchanger in the flow direction of the air stream, through which the air stream may flow, and having a resistance heating element, and
an air guiding flap by means of which portions of the air stream, depending on their position, may be led past the second heat exchanger.

Air conditioning devices of this type are known from EP 1 522 434 A1.

The cited publication discloses a motor vehicle air conditioner, having in its housing an air guiding channel between a blower and a mixing chamber, from which distributor channels lead to vents in the passenger compartment of the motor vehicle. An air filter and an evaporator of a refrigerant circuit are successively situated, in the direction of the air stream, in the air guiding channel from the blower to the mixing chamber. Both elements essentially completely fill the cross section of the air guiding channel, so that the entire air stream originating from the blower initially flows through the filter, then through the evaporator. Cooling and dehumidification of the air stream hereby take place.

A heating module is situated in the air flow direction, downstream from the evaporator and at a distance therefrom and arranged perpendicular thereto, i.e., parallel to the previous air flow direction. The air flowing through the evaporator changes its flow direction downstream from same, and may flow either directly in the space between the evaporator and the heating module, or via the bypass, through the heating module and into the mixing chamber. Counterheating of the air that is cooled in the evaporator may take place in this way. The heating module is made up of a main heater and an auxiliary heater. The main heater is designed as an air/refrigerant heat exchanger and is connected to the refrigerant circuit of the motor vehicle, via which the refrigerant circuit is fed with waste heat of the internal combustion engine. The auxiliary heater is designed as a resistance heating element, in particular a positive temperature coefficient (PTC) heating element, so that counterheating of the air stream is possible even at the start of driving, when the refrigerant is not yet sufficiently heated.

A mixing flap having a cylindrical segment-like design is situated at the inlet of the mixing chamber. In a first extreme position, the two wings of the mixing flap on the one hand close the connection between the air-side outlet of the heating module and the space between the evaporator and the heating module, and on the other hand close the connection between the outlet of the heating module and the mixing chamber. In this position, the air downstream from the evaporator can enter the mixing chamber solely via a direct path, i.e., without counterheating. In its second extreme position, the mixing flap with its wings on the one hand likewise closes the connection between the air-side outlet of the heating module and the space between the evaporator and the heating module, and on the other hand closes the direct connection between the evaporator and the mixing chamber. In this position, the entire air stream downstream from the evaporator initially flows through the heating module, and then, with full counterheating, enters the mixing chamber. Between these two extreme positions, intermediate positions are possible in which in each case portions of the air stream flow through one or the other of the air paths described above. A certain level of air stratification hereby develops in the mixing chamber, which is utilized to supply vertical channels, which adjoin the mixing chamber and lead into the floorboard of the passenger compartment, with warmer air, and to supply vertical channels that lead to higher areas in the passenger compartment with colder air.

In partially or completely electrically operated motor vehicles, the capacity of the refrigerant circuit is very small. The air/refrigerant heat exchanger, still used in the prior art as the main heater, therefore becomes less important, and sometimes may even be dispensed with entirely. The electric heat exchanger becomes even more important; however, with regard to the cruising range problem with an electric vehicle, efficient utilization of the available electrical energy is of particular significance. Adaptation of the known air conditioning device by simply resizing the individual elements of the heating module, even dispensing with the air/refrigerant heat exchanger and providing a correspondingly large design of the electric heat exchanger, would therefore be inadequate.

The object of the present invention is to refine a generic air conditioning device in such a way that it achieves the energy efficiency necessary for use in electric vehicles.

This object is achieved, in conjunction with the features of the preamble of claim 1, in that the air guiding flap is designed as a bypass flap and
portions of the air stream, depending on their position, may be led past the first heat exchanger and
each portion of the air stream, depending on its position, flows through either both or none of the heat exchangers.

Instead of the mixing flap at the inlet of the mixing chamber, a side path of the air guiding channel, which bypasses the evaporator, is provided which may be opened and closed with a dedicated air guiding flap. In the context of the present description, this is understood to mean a “bypass flap.” In addition, the evaporator and the heater are situated in such a way that the bypass flap, as the single air guiding flap, decides whether a given portion of the air stream flows at all through one of the two heat exchangers, or is led past both heat exchangers. In other words, each portion of the air stream that flows through the first heat exchanger also flows through the second heat exchanger. Air stream portions that do not flow through the first heat exchanger also do not flow through the second heat exchanger. Likewise, there are no air stream portions that would pass through only the second, but not the first, heat exchanger.

This may be assisted in particular by the first and the second heat exchanger being spatially situated in parallel to one another, preferably in direct proximity to one another.

This concept is based on the finding that the heater in an electric vehicle, which, as described above, generates heat essentially by electrical means, and in particular may be made up solely of electric heating elements, is controllable, at least down to low temperatures over a fairly large temperature range, as an air/refrigerant heat exchanger that is integrated into a refrigerant circuit. In particular, an electric heater may be switched off with virtually no time delay and without having to conduct heat to another location in compensation, so that no further heat is exchanged with the air flowing through the electric heater. This is its energy-saving operating mode. To prevent excessively cold air from flowing into the mixing chamber due to the absent or reduced counterheating, cooling of the entire air stream may be dispensed with by means of the bypass flap. The portions of the air stream that are led past or to the evaporator may be selected via a suitable control and regulation technology that takes into account on the one hand the desired temperature in the passenger compartment, and on the other hand, the instantaneous humidity and thus, the need for dehumidification of the air stream. The division of the air stream is then achieved by a specially selected flap position of the bypass flap.

In one refinement of the invention, the counterheating may be assisted by an additional, third heat exchanger. A third heat exchanger that is operable as a condenser of the refrigerant circuit and designed as an air/refrigerant heat exchanger is preferably used for this purpose. It is known that each refrigerant circuit includes a compressor for compressing the refrigerant, and a condenser for subsequently cooling or condensing the refrigerant (the term “condenser” is also used here for gas coolers of refrigerant circuits containing noncondensing refrigerants). This condenser is typically connected to the vehicle surroundings, and releases the heat that is withdrawn from the refrigerant to the outside as waste heat. However, in the stated refinement of the invention, which involves assisting the electric heater, this heat that arises in the condenser may be specifically used for the stated purpose.

In one preferred embodiment of this refinement, the above-described direct proximity of the first and second heat exchangers is dispensed with. Instead, the third heat exchanger is situated between the first and the second heat exchanger in the flow direction.

Alternatively, it may be provided that the first heat exchanger has at least two differently controllable segments that adjoin one another vertically, of which at least the lower segment is operable as a condenser of the refrigerant circuit. The basic concept of this embodiment corresponds to the concept discussed above, of utilizing the heat that arises at the condenser of the refrigerant circuit for assisting the electric second heat exchanger. However, no third heat exchanger is used here, and instead the first heat exchanger is vertically segmented, so that its vertically lower area may be used for heating, and its vertically upper area may be used for cooling, the air stream. Lower air stream portions may thus undergo heating twice, namely, heating in the lower segment of the first heat exchanger and optionally, subsequent heating in the electric second heat exchanger. In contrast, upper air stream portions may undergo cooling in the upper segment of the first heat exchanger, and optionally, subsequent heating in the second heat exchanger. Of course, the air stream portion led across the side path (bypass flap) is unaffected thereby. In this embodiment, particularly favorable temperature stratification in the subsequent mixing chamber, with temperature decreasing toward the top, is created. This corresponds to the temperature stratification, described at the outset, for the differently temperature-controlled supplying of different distributor channels.

As another alternative, it is possible for the second heat exchanger to have at least two differently controllable, vertically adjoining segments, of which the upper segment is made up of one or more resistance heating elements, and the lower segment is operable as a condenser of the refrigerant circuit. The above-described concept of vertically segmenting a heat exchanger in the area of the second heat exchanger is implemented in this embodiment. The heat exchanger operates electrically in its upper area, and is operable as a condenser of the refrigerant circuit in its lower area. The preferred temperature stratification in the mixing chamber may be achieved in this way. In particular, in cases in which the passenger compartment in higher zones is to be cooled, and floorboards are to be heated, this arrangement is particularly energy-efficient, since in particular there is little or no need for energization of the electric portion of the second heat exchanger.

In all cases, it is advantageous when the heat exchangers in each case have at least two differently controllable segments that adjoin one another horizontally, and transversely with respect to the flow direction. Namely, horizontal temperature differentiation may also be created in this way in the mixing chamber, so that the temperature of the driver and front passenger side of the passenger compartment may be controlled differently (provided that appropriately situated vertical channels exit the mixing chamber, which, however, is quite common).

Further features and advantages of the invention result from the following detailed description and the drawings, which show the following:

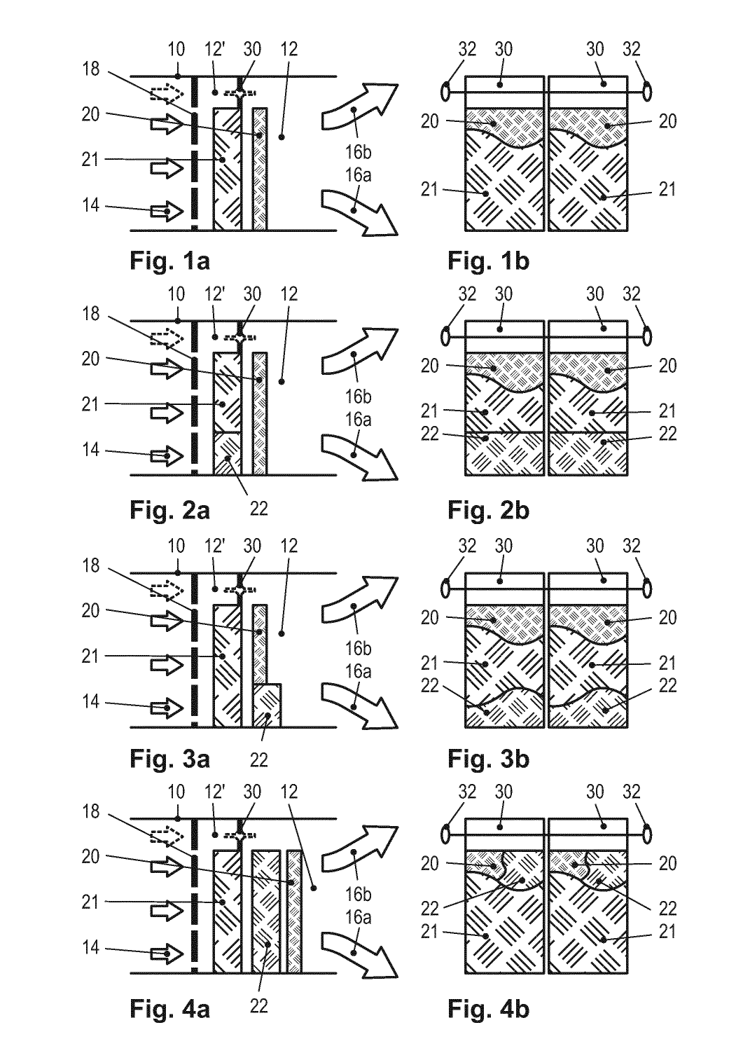

FIG. 1 shows a first embodiment of an internal heat exchanger arrangement,

FIG. 2 shows a second embodiment of an internal heat exchanger arrangement,

FIG. 3 shows a third embodiment of an internal heat exchanger arrangement,

FIG. 4 shows a fourth embodiment of an internal heat exchanger arrangement,

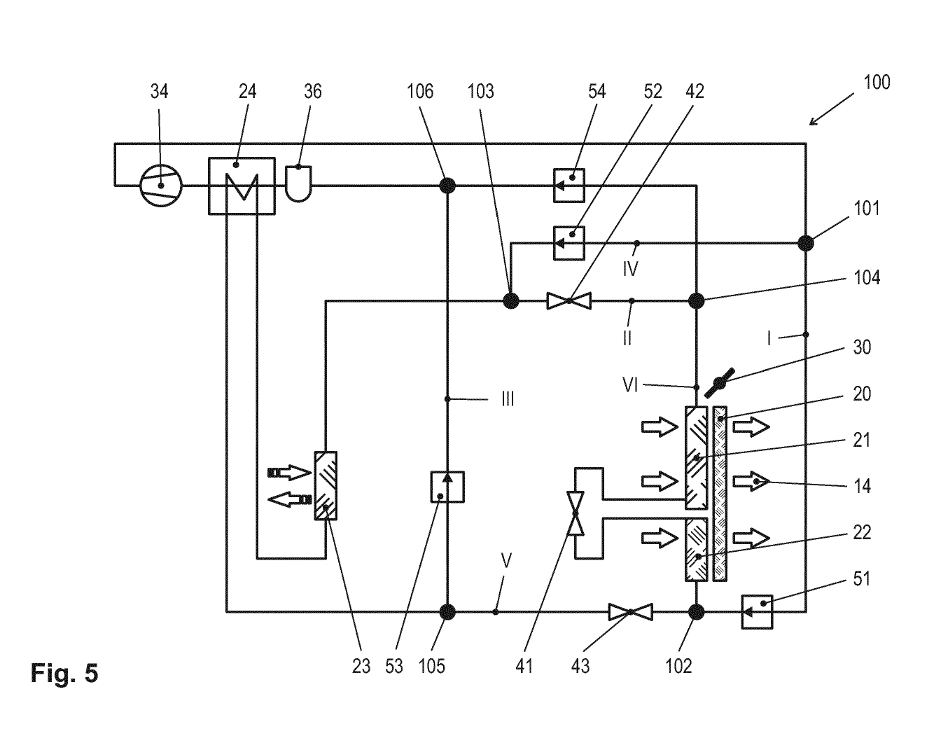

FIG. 5 shows a refrigerant circuit using an internal heat exchanger arrangement according to FIG. 2,

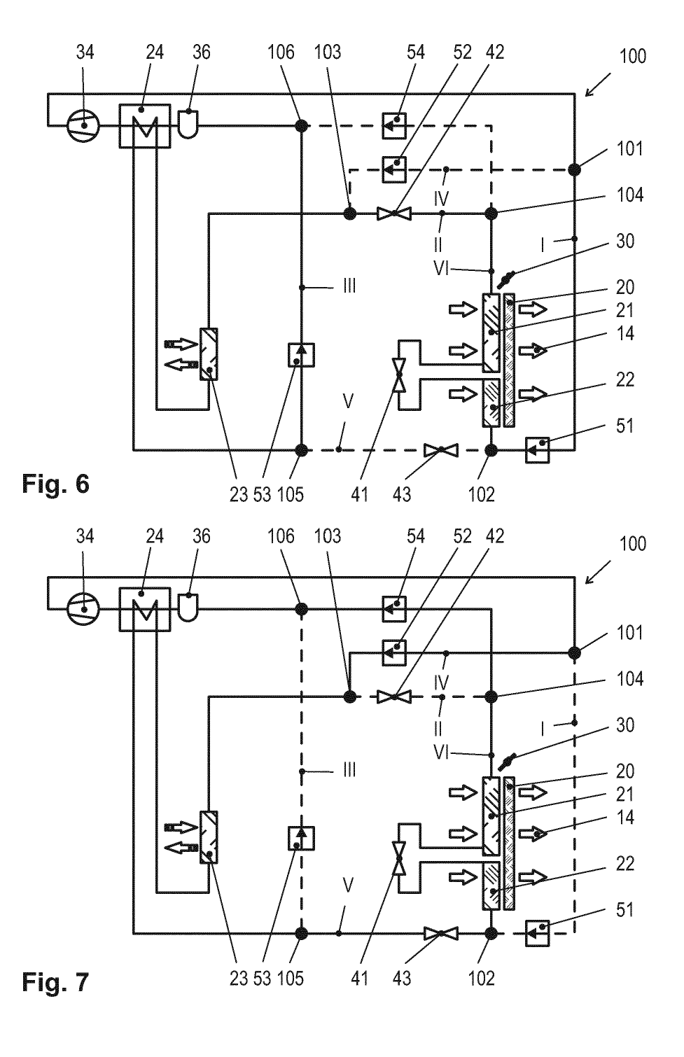

FIG. 6 shows the refrigerant circuit from FIG. 5 in heat pump mode,

FIG. 7 shows the refrigerant circuit from FIG. 5 in cooling mode,

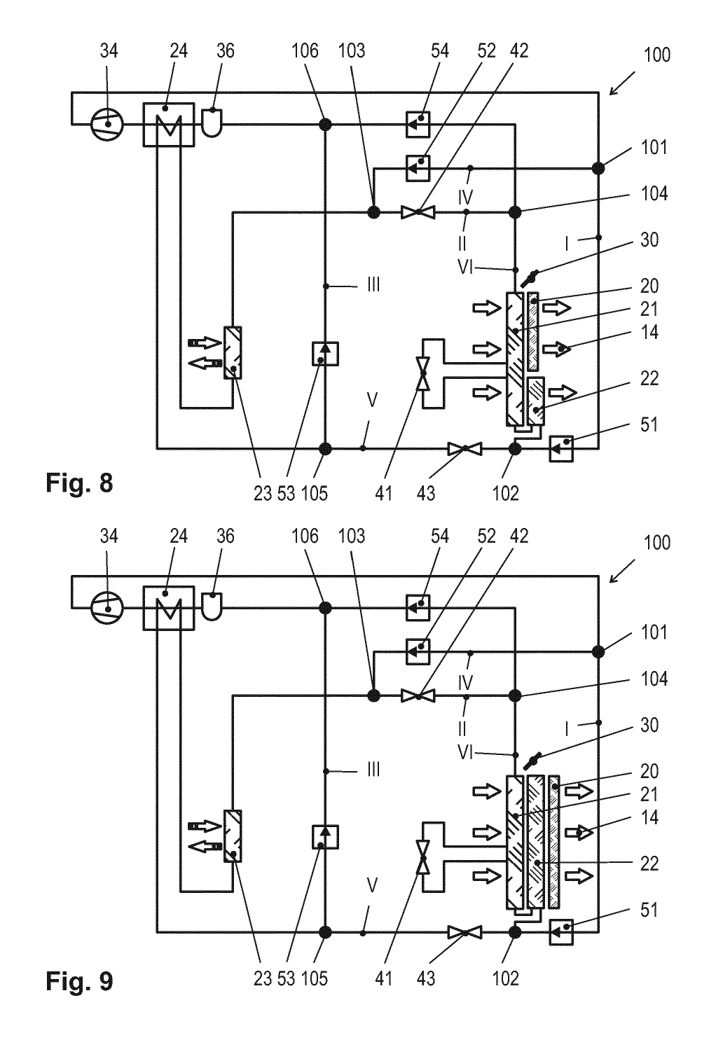

FIG. 8 shows a refrigerant circuit using an internal heat exchanger arrangement according to FIG. 3, and

FIG. 9 shows a refrigerant circuit using an internal heat exchanger arrangement according to FIG. 4.

Identical or analogous elements are denoted by the same reference numerals in the figures.

FIGS. 1 through 4 show different internal heat exchanger arrangements, of which those in FIGS. 2 through 4 may particularly advantageously find use in conjunction with the refrigerant circuit connection described below, as illustrated in FIGS. 5 through 9. Subfigures 1a through 4a each illustrate a vertical longitudinal section parallel to the air guiding channel extension. Subfigures 1b through 4b illustrate partially cutaway views of the heat exchanger, viewed in the direction of the air stream.

An air guiding channel 12 is formed in a housing 10, not illustrated in detail. An air stream 14 may flow through the air guiding channel 12, the air stream typically being generated by an upstream blower and led into a downstream mixing chamber, from where it is led across further vertical channels to vents in the passenger compartment. Strictly by way of example, FIGS. 1 through 4 illustrate substreams 16a that are directed into the floorboard of the passenger compartment, and substreams 16b that are directed into the headroom of the passenger compartment.

The embodiments in FIGS. 1 through 4 share the common feature of an optional filter 18 that spans the air guiding channel and keeps dust, pollen, and other contaminants from entering the downstream internal heat exchangers and the passenger compartment. The term “internal heat exchanger” is intended to mean that temperature-controlled air can flow in this element and into the interior of the passenger compartment. In addition, the embodiments in FIGS. 1 through 4 have an electric heat exchanger segment 20, made up of resistance heating elements, preferably so-called positive temperature coefficient (PTC) resistance elements. In all embodiments in FIGS. 1 through 4, a first air/refrigerant heat exchanger segment 21 is situated between the optional filter 18 and the electric heat exchanger segment 20, i.e., on the upstream air side of the electric heat exchanger segment 20. The embodiments in FIGS. 2 through 4 additionally show a second air/refrigerant heat exchanger segment 22 which, depending on the embodiment, together with the first air/refrigerant heat exchanger segment 21 forms the first heat exchanger according to the claims (FIG. 2), together with the electric heat exchanger segment 20 forms the second heat exchanger according to the claims (FIG. 3), or independently forms the third heat exchanger according to the claims (FIG. 4).

A bypass flap 30 that closes or opens the side path 12′ of the air guiding channel 12 that bypasses the heat exchanger segments 20, 21, 22, depending on the switching position, is characteristic of all embodiments in FIGS. 1 through 4. The closed flap position is illustrated by solid lines in FIGS. 1 through 4. The open flap position is additionally illustrated by dashed lines in subfigures 1a through 4a. The entire air stream 14 is forced through the heat exchanger segments 20, 21, 22 in the closed flap position, so that heat transfer takes place between the refrigerant and the air, and between the resistance heating elements and the air. In contrast, in the open flap position the major portion of the air stream 14 will flow across the side path 12′ due to the lower flow resistance, so that essentially no heat transfer takes place.

The differences in the embodiments in FIGS. 1 through 4 are discussed below.

FIG. 1 illustrates the simplest embodiment. The electric heat exchanger segment 20 and the first air/refrigerant heat exchanger segment 21 here occupy essentially the same region of the cross section of the air guiding channel 12. The electric heat exchanger segment 20 is situated downstream from the first air/refrigerant heat exchanger segment 21 in the air flow direction. The bypass flap 30 is situated in the upper area of the air guiding channel 12, so that its side path 12′ extends in the upper edge area of the air guiding channel 12. For flap positions of the bypass flap 30 that allow a substantial flow portion through the heat exchanger segments 20, 21 as well as a substantial flow portion across the side path 12′, this results in temperature stratification in the downstream mixing chamber. This may be utilized in particular to allow a warmer substream 16a to flow into the floorboard and a cooler substream 16b to flow into the headroom of the passenger compartment. As indicated in subfigure 1b, lateral segmentation of the heat exchanger segments 20, 21 is additionally provided, the individual lateral segments preferably being separately controllable. When the downstream mixing chamber has appropriate lateral branching, it is thus possible to control the temperature of the driver and front passenger compartment differently. The bypass flap 30 is preferably automatically controllable, for which purpose the actuators 32 indicated in subfigure 1b may be used.

In addition to the position of the bypass flap 30 and the lateral segmentation of the heat exchanger segments 20, 21, in particularly preferred embodiments it is possible for even finer differentiation of the temperature to take place. This is due in particular to the fact that in such embodiments, the electric heat exchanger segment 20 is made up of a plurality of independently controllable resistance heating elements.

In the embodiment in FIG. 2, a second air/refrigerant heat exchanger segment 22 is additionally provided that is situated vertically beneath the first air/refrigerant heat exchanger segment 21. In particular in the context of the refrigerant circuit connections to be described in greater detail below, it is possible to operate the second air/refrigerant heat exchanger segment 22 in heating mode and the first air/refrigerant heat exchanger segment 21 in cooling mode, resulting in improved temperature stratification in the downstream mixing chamber. On the other hand, it is also possible to operate the first and the second heat exchanger segment 21, 22 at the same temperature, or in particular to operate them together in the cooling or heating mode, but at different temperatures. The electric heat exchanger segment 20 may be used as an auxiliary heater or counterheater. Those skilled in the art recognize that an extremely flexible design of the temperature stratification in the mixing chamber is thus made possible. In other respects, analogous reference is made to the above discussion for FIG. 1.

In the embodiment from FIG. 3, the second air/refrigerant heat exchanger segment 22 is situated vertically beneath the electric heat exchanger segment 20 and downstream from the first air/refrigerant heat exchanger segment 21 in the air flow direction. Here as well, a very flexible design of the temperature stratification in the mixing chamber results, although the influence of the first air/refrigerant heat exchanger segments 21 increases at the expense of the influence of the electric heat exchanger segment 20. In other respects, analogous reference is made to the above discussion for FIG. 1.

Lastly, FIG. 4 illustrates a variant in which the electric heat exchanger segment 20, the first air/refrigerant heat exchanger segment 21, and the second air/refrigerant heat exchanger segment 22 all occupy essentially the same region of the air guiding channel cross section. Similarly as for the embodiment from FIG. 1, the temperature stratification in the mixing chamber here is essentially regulated by the bypass flap 30 and optionally also by small-scale controllability of the electric heat exchanger segment 20. However, greater flexibility in the temperature control is provided here due to the larger number of controllable heat exchanger segments 20, 21, 22.

FIG. 5 shows a particularly advantageous circuit design of a refrigerant circuit 100, in which the internal heat exchanger arrangement from FIG. 2 is used (without the optional filter 18, which of course may also be used here). As illustrated in FIGS. 8 and 9, essentially the same circuitry may also be achieved by using the internal heat exchanger arrangement in FIGS. 3 and 4. The following discussion, which focuses on the refrigerant circuit 100 from FIG. 5, thus also applies in its entirety to the refrigerant circuits 100 in FIGS. 8 and 9, with consideration of the comments made with regard to FIGS. 3 and 4.

The refrigerant circuit 100 includes a compressor 34 via which refrigerant is compressible. The outlet of the compressor 34 is connected to a first branch point or opening point 101 via a refrigerant line. The terms “branch point” and “opening point” are used interchangeably here. Two refrigerant line sections diverge from the first branch point 101, namely, a first refrigerant line section I and a fourth refrigerant line section IV. The first refrigerant line section I contains a first shutoff valve 51 and ends at a second branch point or opening point 102. The fourth refrigerant line section IV contains a second shutoff valve 52 and ends at a third branch point or opening point 103. The second opening point 102 is connected to the inlet of the second air/refrigerant heat exchanger segment 22. The outlet of the second air/refrigerant heat exchanger segment 22 is connected to the inlet of the first air/refrigerant heat exchanger segment 21 via a first expansion valve 41. The outlet of the first air/refrigerant heat exchanger segment 21 is connected to a fourth branch point or opening point 104, which in turn is connected to the third opening point 103 via a second refrigerant line section II that contains a second expansion valve 42.

The second opening point 102 is additionally connected to a fifth branch point or opening point 105 via a fifth refrigerant line section V that contains a third expansion valve 43. The fifth branch point or opening point 105 is connected on the one hand to the high-pressure outlet of an internal heat exchanger 24 designed as a refrigerant/refrigerant heat exchanger, and on the other hand is connected via a third refrigerant line section III, containing a third shutoff valve 53, to a sixth branch point or opening point 106, which via a collector 36 is in turn connected to the low-pressure inlet of the internal heat exchanger 24, whose low-pressure outlet is connected to the inlet of the compressor 34.

The low-pressure inlet of the internal heat exchanger 24 is connected to the outlet of a coupling heat exchanger 23 which is designed as a refrigerant/refrigerant heat exchanger, and which on the refrigerant side is a component of a refrigerant circuit, not illustrated in greater detail, which may be used, for example, to cool a drive unit and/or its electronics system. A refrigerant circuit for cooling an internal combustion engine is conceivable. The refrigerant circuit may likewise be used to cool an electric drive unit and/or its electronics system, in particular the power electronics system and the traction batteries. Also conceivable is a design of the coupling heat exchanger as an external heat exchanger designed as an air/refrigerant heat exchanger. However, this is less energetically favorable.

At the input side the coupling heat exchanger 23 is connected to the third opening point 103.

Lastly, the fourth branch point 104 is connected to the sixth opening point 106 via a sixth refrigerant line section VI containing a fourth shutoff valve 54.

The preferred operating modes of the refrigerant circuit 100 from FIG. 5 are explained with reference to FIGS. 6 and 7. The respectively active sections of the refrigerant line, i.e., through which refrigerant flows, are illustrated by solid lines in FIGS. 6 and 7. The sections that are blocked in the particular mode, i.e., through which refrigerant does not flow, are shown in dashed lines.

FIG. 6 shows the refrigerant circuit 100 in heat pump mode. For this purpose, the first shutoff valve 51 is open and the second shutoff valve 52 is closed. Refrigerant that is compressed by the compressor 34 thus flows through the first refrigerant line section I, whereas there is no flow through the fourth refrigerant line section IV. As an alternative to the arrangement of the shutoff valves 51, 52 in the first and fourth refrigerant line sections I, IV, respectively, it would be possible to install a switchable two-way valve at the first branch point 101. In addition, in heat pump mode the third shutoff valve 53 is open and the fourth shutoff valve 54 is closed. Refrigerant may thus flow through the third refrigerant line section III, while the sixth refrigerant line section VI is blocked. As an alternative to the arrangement of the third and fourth shutoff valves 53, 54 in the third and sixth refrigerant line sections III, VI, respectively, a two-way valve could be used at the sixth opening point 106.

Furthermore, the heat pump mode is additionally characterized in that the fifth refrigerant line section V is likewise blocked. In the illustrated embodiment, the third expansion valve 43 is used for this purpose. Alternatively, an additional shutoff valve in the fifth refrigerant line section V could be used for this purpose.

The refrigerant compressed in the compressor 34 thus flows through the first refrigerant line section I into the second air/refrigerant heat exchanger segment 22. In this mode, the latter is operated as a condenser, and transfers heat from the refrigerant to the air stream 14. From the outlet of the second air/refrigerant heat exchanger segment 22, the refrigerant passes across the first expansion valve 41 to the first air/refrigerant heat exchanger segment 21. Depending on the position of the first expansion valve 41, the pressure drop may be adjusted in such a way that the first air/refrigerant heat exchanger segment 21 is likewise operated either as a condenser at essentially the same temperature level as the second air/refrigerant heat exchanger segment 22, as a condenser but at a lower temperature level than the second air/refrigerant heat exchanger segment 22, or as an evaporator that withdraws heat from the air stream 14 flowing through it. The adjustment of the first expansion valve 41 typically takes place within the scope of a regulation for achieving a desired temperature stratification in the downstream mixing chamber, not shown separately. In the illustrated embodiment, the air stream 14 downstream from the first and second air/refrigerant heat exchanger segments 21, 22 still flows through the electric heat exchanger segment 20, where auxiliary heating or counterheating may take place. With regard to the circuit design of the refrigerant circuit 100, however, the electric heat exchanger segment 20 may be regarded as optional.

Downstream from the first air/refrigerant heat exchanger segment 21, the refrigerant at the fourth branch point 104 flows into the second refrigerant line section II, since due to the blocked position of the fourth shutoff valve 54, the sixth refrigerant line section VI, which likewise diverges from the fourth branch point 104, is blocked. Further expansion of the refrigerant takes place in the second expansion valve 42, which is contained in the second refrigerant line section II; in any case, the pressure of the refrigerant should be low enough that the downstream coupling heat exchanger 23 is operated as an evaporator which absorbs heat from the adjoining refrigerant circuit.

Downstream from the coupling heat exchanger 23, the refrigerant flows through the high-pressure portion of the internal heat exchanger 24. It is recognized by those skilled in the art that the high-pressure portion of the internal heat exchanger as well as the collector 36 are strictly optional, and depend essentially on the refrigerant selected. Also conceivable is a direct connection of the outlet of the coupling heat exchanger 23 to the fifth opening point 105, to which the high-pressure outlet of the internal heat exchanger 24 is connected in the illustrated embodiment.

From here, the refrigerant flows through the open third shutoff valve 53 and the third refrigerant line section III, and passes through the sixth opening point 106, the low-pressure portion of the internal heat exchanger 24, and back to the compressor 34.

FIG. 7 shows the refrigerant circuit 100 in cooling mode. The first shutoff valve 51 is closed and the second shutoff valve 52 is open. In addition, the third shutoff valve 53 is closed and the fourth shutoff valve 54 is open. The third expansion valve 53 is in controlled operation in this mode. In contrast, the second expansion valve 52 is closed and blocks the second refrigerant line section II, for which reason in an alternative embodiment, an additional shutoff valve could be used in the second refrigerant line section II.

The refrigerant compressed by the compressor 34 branches off into the fourth refrigerant line section IV at the first branch point 101, and passes through the third opening point 103 to the inlet of the coupling heat exchanger 23, which in this mode is operated as a condenser and releases heat to the adjoining refrigerant circuit. After passing through the high-pressure portion of the optional internal heat exchanger 24, the refrigerant at the fifth branch point 105, due to the closed third shutoff valve 53, flows into the fifth refrigerant line section V, where it is expanded by means of the third expansion valve 43.

Since the first shutoff valve 51 is closed, the expanded refrigerant flows from the second opening point 102 into the second air/refrigerant heat exchanger segment 22. Depending on the adjustment of the third expansion valve 43, the second air/refrigerant heat exchanger segment 22 may be utilized as a further condenser in order to release heat to the portion of the air stream 14 flowing through it. However, the second air/refrigerant heat exchanger segment may also be operated as an evaporator, absorbing heat from the portion of the air stream 14 flowing through it. In practice, depending on the desired temperature stratification, the adjustment is made in the mixing chamber, not illustrated. On the refrigerant side downstream from the second air/refrigerant heat exchanger segment 22, the refrigerant undergoes further expansion in the first expansion valve 41 and subsequently flows through the first air/refrigerant heat exchanger segment 21, which in this mode in any case is operated as an evaporator in order to absorb heat from the portion of the air stream 14 flowing through it.

At the fourth branch point 104, situated on the refrigerant side downstream from the first air/refrigerant heat exchanger segment 21, due to the closed second expansion valve 42 the refrigerant flows into the sixth refrigerant line section and through the open fourth shutoff valve 54 to the collector 36, and through the low-pressure portion of the optional internal heat exchanger 24 back to the compressor 34.

Those skilled in the art will recognize that the three nonoptional heat exchangers or heat exchanger segments, namely, the first air/refrigerant heat exchanger segment 21, the second air/refrigerant heat exchanger segment 22, and the coupling heat exchanger 23, may each be operated as a condenser as well as an evaporator in the described refrigerant circuit 100. By suitable adjustment of a few switching and control elements, operation of the refrigerant circuit 100 in two fundamental modes is possible, namely, a heat pump mode and a cooling mode, wherein within each of the two modes, depending on the requirements, differentiated temperature stratification is possible in the mixing chamber on the air side downstream from the internal heat exchangers. In this way, the temperature distribution in the passenger compartment may be adjusted in a particularly flexible and individual manner.

Of course, the embodiments discussed in the detailed description and shown in the figures represent only illustrative exemplary embodiments of the present invention. In light of the present disclosure, those skilled in the art are provided with a broad spectrum of variation options.

### List of Reference Numerals

10 housing
12 air guiding channel
12′ side path of 12
14 air stream
16a air stream portion to the floorboard
16b air stream portion to the headroom
18 filter
20 electric heat exchanger segment
21 first air/refrigerant heat exchanger segment
22 second air/refrigerant heat exchanger segment
23 coupling heat exchanger
24 internal heat exchanger
30 bypass flap
32 actuator
34 compressor
36 collector
41 first expansion valve
42 second expansion valve
43 third expansion valve
51 first shutoff valve
52 second shutoff valve
53 third shutoff valve
54 fourth shutoff valve
100 refrigerant circuit
101 first branch/opening point
102 second branch/opening point
103 third branch/opening point
104 fourth branch/opening point
105 fifth branch/opening point
106 sixth branch/opening point
I first refrigerant line section
II second refrigerant line section
III third refrigerant line section
IV fourth refrigerant line section
V fifth refrigerant line section
VI sixth refrigerant line section

1. An air conditioning device for a motor vehicle, comprising, situated in a housing;
a first heat exchanger through which an air stream may flow and which is operable as an evaporator of a refrigerant circuit,
a second heat exchanger, connected downstream from the first heat exchanger in the flow direction of the air stream, through which the air stream may flow, and having a resistance heating element, and
an air guiding flap by means of which portions of the air stream, depending on their position, can be led past the second heat exchanger, wherein
the air guiding flap is designed as a bypass flap,
portions of the air stream, depending on their position, may be led past the first heat exchanger, and
each portion of the air stream, depending on its position, flows through either both or none of the heat exchangers.

2. The air conditioning device according to claim 1, wherein the first and the second heat exchanger are spatially situated in parallel to one another.

3. The air conditioning device according to claim 1, wherein the first and the second heat exchanger are situated in direct proximity to one another.

4. The air conditioning device according to claim 1, wherein a third heat exchanger that is operable as a condenser of the refrigerant circuit is situated between the first and the second heat exchanger in the flow direction.

5. The air conditioning device according to claim 1, wherein the first heat exchanger has at least two differently controllable segments that adjoin one another vertically, of which at least the lower segment is operable as a condenser of the refrigerant circuit.

6. The air conditioning device according to claim 1, wherein the second heat exchanger has at least two differently controllable, vertically adjoining segments, of which the upper segment is made up of one or more resistance heating elements, and the lower segment is operable as a condenser of the refrigerant circuit.

7. The air conditioning device according to claim 1, wherein the heat exchangers in each case have at least two differently controllable segments that adjoin one another horizontally, and transversely with respect to the flow direction.
